(19) United States
(12) Patent Application Publication
(10) Pub. No.: US 2017/0242458 A1
(43) Pub. Date: Aug. 24, 2017

(54) END-USER-READY MODULAR AND EXPANDABLE MEASUREMENT, CONTROL AND COMMUNICATION SYSTEM AND APPARATUS FOR TIME SHARING INTELLIGENCE AND CONNECTIVITY

(71) Applicant: Sameh Sarhan, Santa Clara, CA (US)

(72) Inventor: Sameh Sarhan, Santa Clara, CA (US)

(73) Assignee: XTRAVA LLC, Santa Clara, CA (US)

(21) Appl. No.: 15/011,335

(22) Filed: Jan. 29, 2016

(51) Int. Cl. G06F 1/16

(52) U.S. Cl. CPC G06F 1/1656; G06F 1/163; G06F 1/1698; H04W 88/02

(57) ABSTRACT

“PERSONAL SMART COMPANION” (“PSC”) SYSTEM
Enables unique sensing applications, including novel biotech applications
Ability to target a wide variety of applications, including home automation, wellness and sports

“PERSONAL SMART COMPANION” intelligent module, that
Includes a combination highly optimized modular hardware & sensor specific machine learning layers
Is equipped with wireless communication in order to support external applications, & to make use of smart phones, smart pad & other computers to provide user interface, additional memory, intense machine learning & other computational functions
Can conveniently be moved to various appliances & other objects

### CROSS-REFERENCE TO RELATED APPLICATION

Priority is claimed under 37 CFR 1.78 and 35 USC 119(e) to U.S. Provisional Application 62/110425 (XT1501301), filed 30 Jan. 2015), which is incorporated by reference.

### TECHNICAL FIELD

This disclosure relates generally to modular end-product electronic systems. More specifically, this disclosure relates to modular end-user-ready electronic measurement, control, and communication systems that employ a miniature “core” module that is “stand alone” user ready and can also be physically and/or electronically incorporated with other modules and subsystems to perform a plethora of useful and convenient functions.

### BACKGROUND

For some years, there have appeared on the market a large number of miniature electronic devices (some worn on the body) that provide useful functions, such as health aids, communication, computation, timing, compass direction, barometric pressure, location, and gesturing. None of these devices is capable of hardware upgrade, expansion, or customization by the user; so the user is forced to purchase complete new devices as functions and features are desired or become available. Moreover, multiple wearable devices worn simultaneously are undesirable, as is battery charging and other management.

### BRIEF DESCRIPTION OF DRAWINGS

For a more complete understanding of this disclosure and its features, reference is now made to the following description, taken in conjunction with the accompanying drawings, in which:

FIG. 1 helps to demonstrate market need for a single wearable module that can be configured for various applications.

FIG. 2 introduces the core module, called the Personal Smart Companion “PSC” that can operate a wide variety of applications in a wide variety of products.

FIG. 3 shows how the PSC can be incorporated in external equipment and make use of software and connectivity to carry out many functions.

FIG. 4 shows benefits to end users and third party developers.

FIG. 5 shows additional details pursuant to FIG. 4.

FIG. 6 shows a rough hardware block diagram of an example PSC.

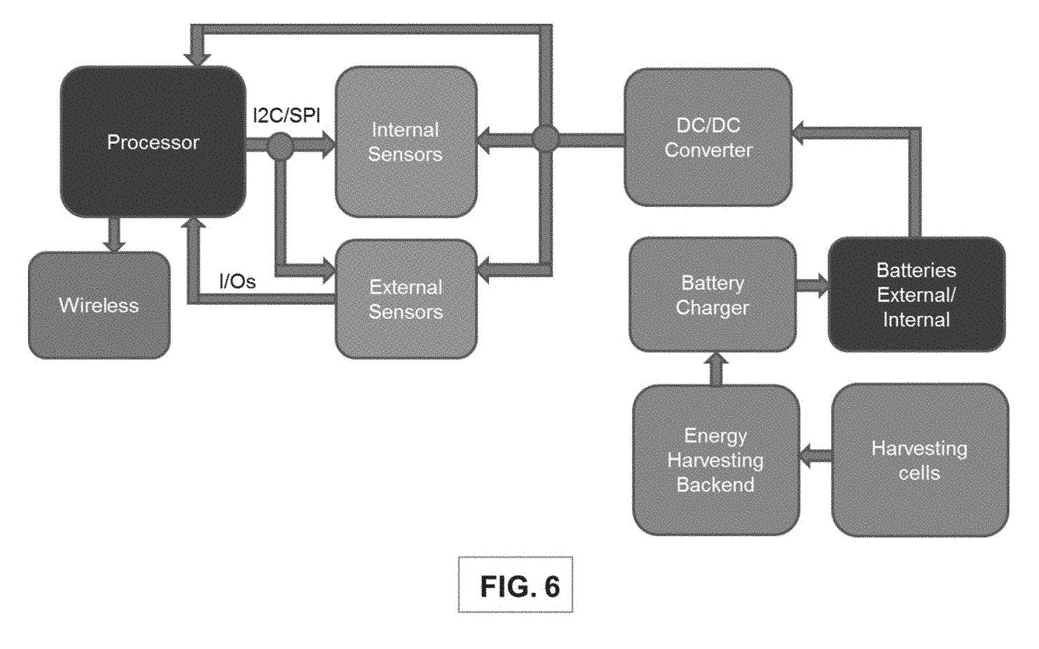

FIG. 7 shows a rough firmware flow diagram of an example PSC application.

FIG. 8 shows a completed prototype PSC under test.

### DETAILED DESCRIPTION

The various figures, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

In general, this disclosure describes the functions and basic design of a system that uses a durable core module referred to here as a “Personal Smart Companion” (“PSC”), which is so small that it can be conveniently inserted into and removed from an attractive low profile wrist-mounted enclosure. It also describes how the PSC module could operate with additional modules within the wrist enclosure, such as sensors for hand and/or finger gesturing, or removed to be installed within or attached to external “add-on” functional subsystems, such as a smart soccer ball, a passive and contactless heart monitoring “badge”, other medical devices, and/or smart appliances such as a meat thermometer. The PSC could communicate wirelessly and operate in conjunction with smart phones, computers, and tablet computers, which assist with real time implementation of firm and machine-learned algorithms, provide bulk data storage, worldwide communications, and a friendly User Interface. Depending upon its location, the PSC could receive varying amounts of assistance to its energy-harvesting power management system.

This apparatus enables intelligence and connectivity among various consumer devices and appliances. One key value is the reduced cost of ownership as compared with purchasing multiple smart devices. Another key value is enhanced user experience-more pleasant and efficient; as there is only a single user interface for multiple devices and appliances. The user also benefits from a standard mechanical interface—an SD card form factor.

Depending on the implementation, this technique can provide significant benefits in a wide range of fields, such as hand and finger gesturing, temperature monitoring of foods and other media, wireless and hands-free heart monitoring, home automation, gaming, and sports adjuncts.

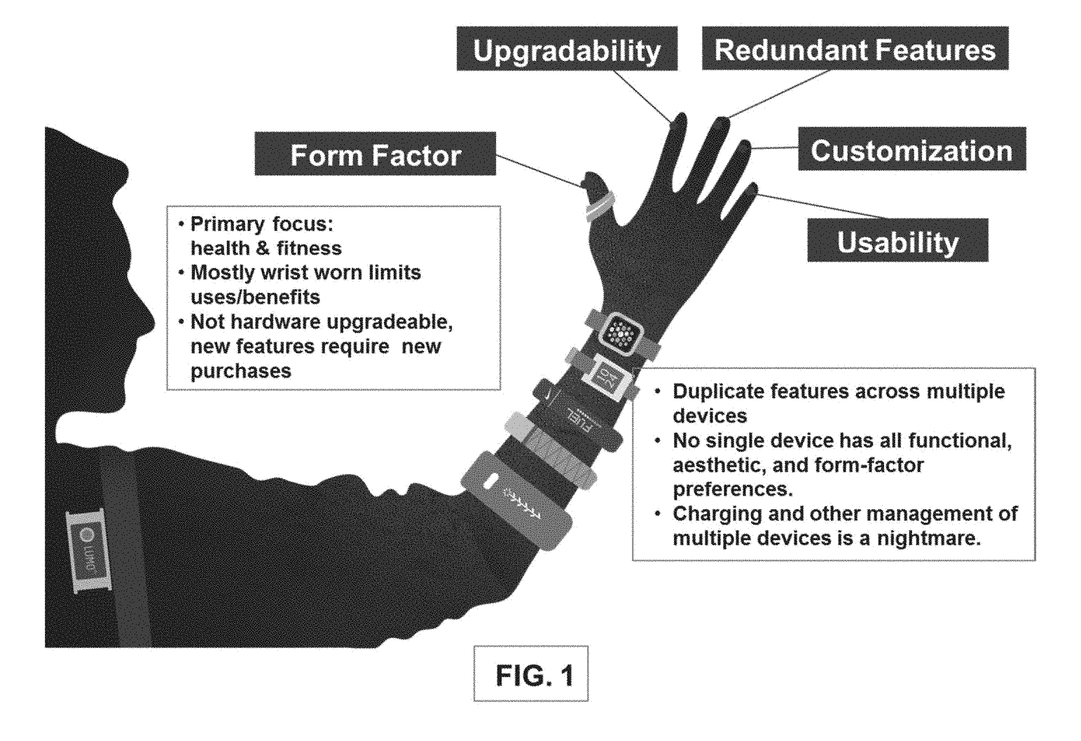

FIG. 1 illustrates the need for the “Personal Smart Companion” system. It depicts examples of the many different hardware modules needed to cover various applications, owing to lack of hardware upgradability.

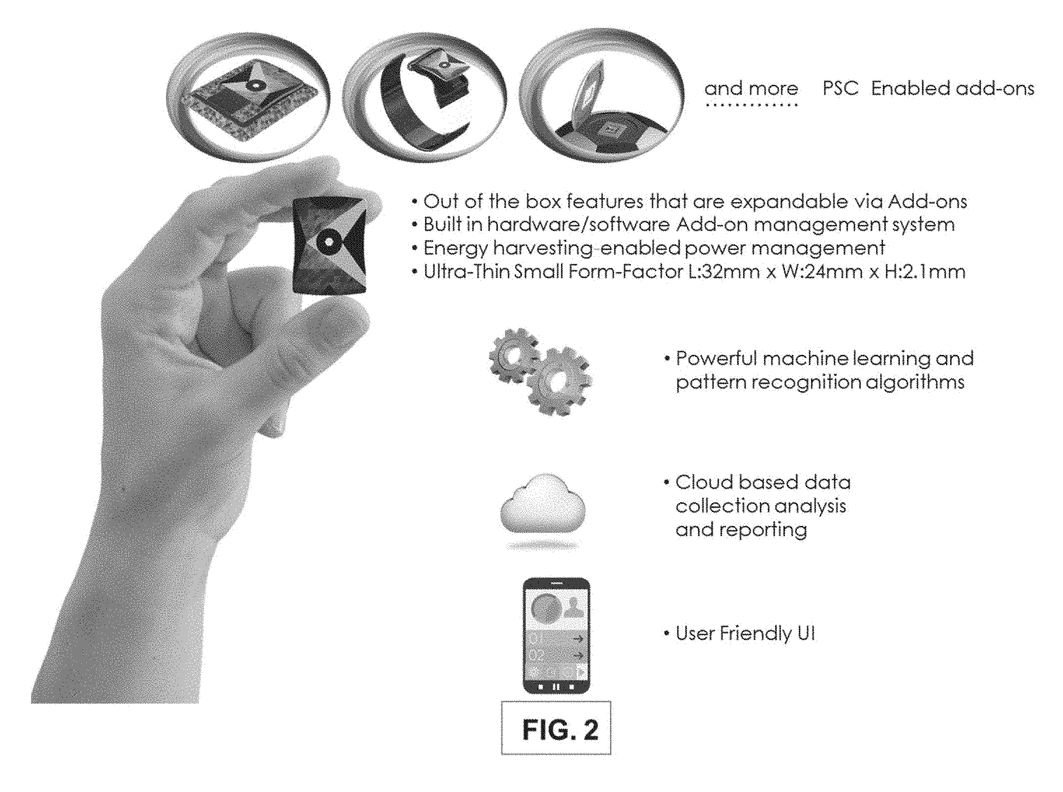

FIG. 2 introduces the “Personal Smart Companion” system idea, a tiny, portable, general purpose module that could operate alone or together with additional modules within a wrist enclosure. This module could contain hardware, software, wireless communication, and sophisticated power management. The additional modules could include various sensors, additional power management functions and other devices.

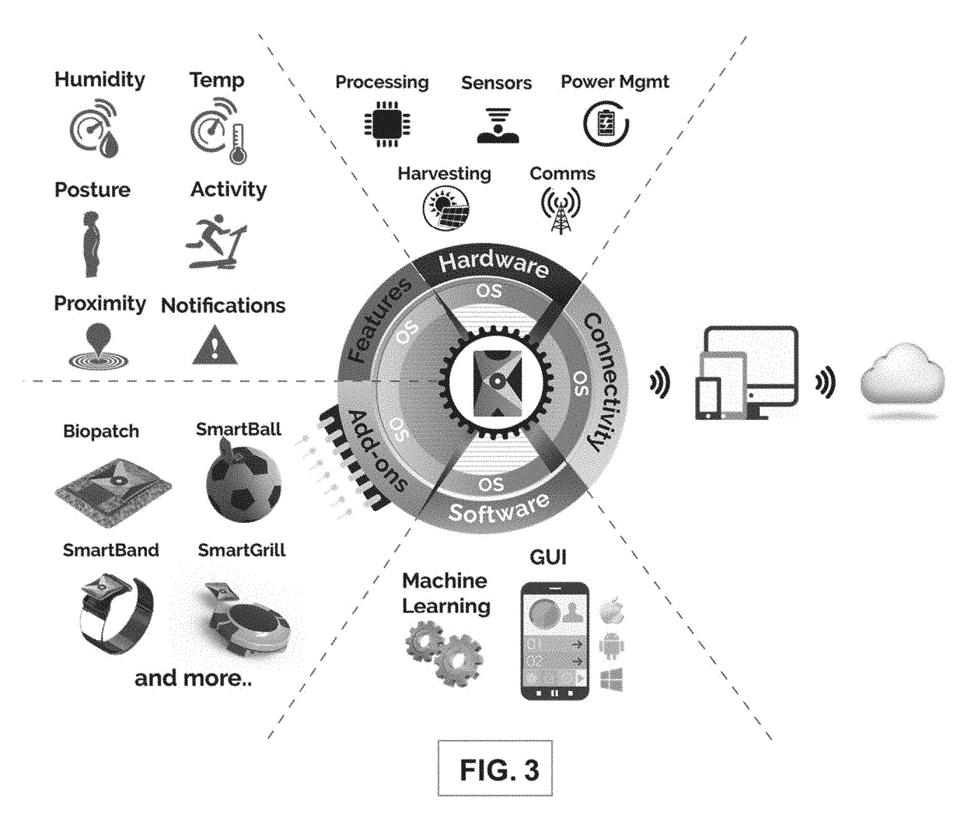

FIG. 3 roughly illustrates the internal functions of the PSC and how it works together with external modules having a plethora of applications. The Figure also shows the PSC communicating with external computing and communications devices for user interface, machine learning and algorithm support, monitoring of functions throughout the world and beyond, and programming for upgrades and new applications.

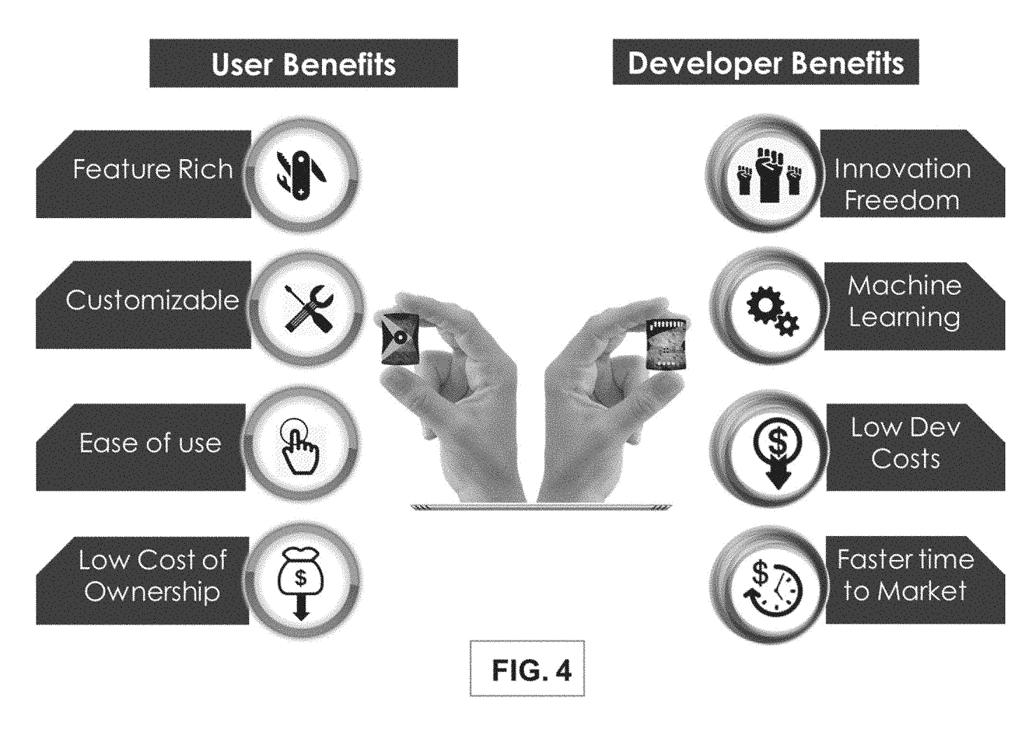

FIG. 4 summarizes benefits to end users and firmware developers. “Feature Rich” and “Customizable” refer to the many features derived from firmware variations in the PSC and added capabilities written for the computer, tablet, and smart phone. They also derive from adding modules to the wrist enclosure and physically joining the PSC with external appliances and other objects. “Ease of Use” refers to the fact that every feature and application, present or future, will operate using the same user interface and format. “Low Cost of Ownership” refers to the fact that a single PSC may be transferred as necessary to the various appliances and other objects. Therefore, the user may purchase only a single PSC or a very small quantity to cover all uses, instead of having to purchase a smart electronic device for each application. FIG. 4 also shows benefits to third party developers of new features and applications.

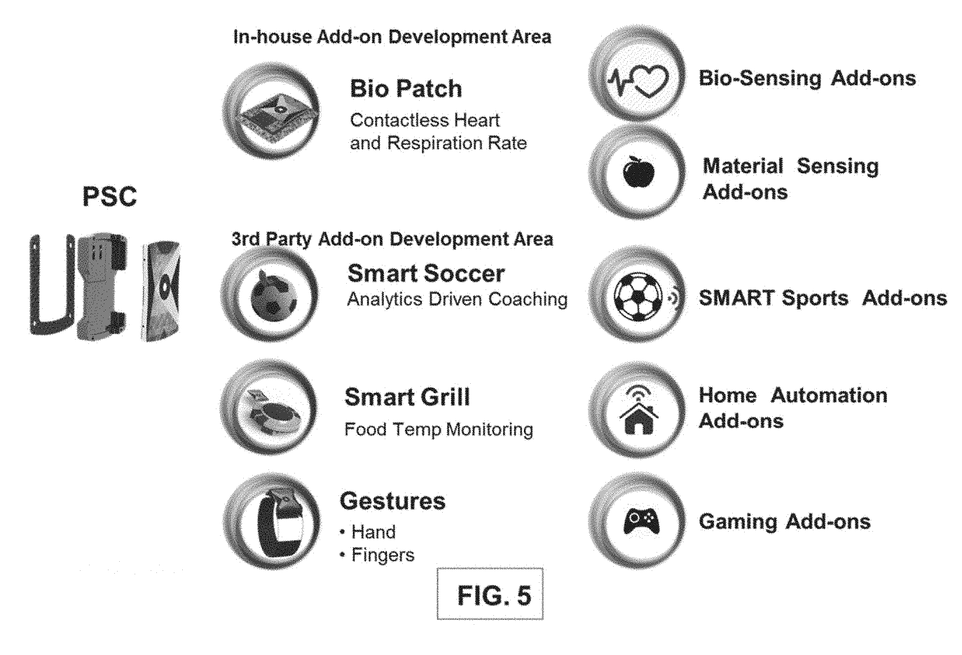

FIG. 5 shows additional detail of uses that involve adding additional modules to the wrist enclosure (“Gestures”) and moving the PSC to appliances and other objects. These applications can be supported by third parties or otherwise. The same basic technology that supports contactless and wireless heart and respiration rate can also support other bio-sensing functions and the sensing of chemical properties of other materials.

FIG shows a simplified block diagram of the example as-built and functional “Personal Smart Companion” module. It uses off-the-shelf microprocessor, RF transceiver, and power management integrated circuitry. Internal sensors could include accelerometers, microphones, temperature, etc. External sensors could include magnetometers and electrometers.

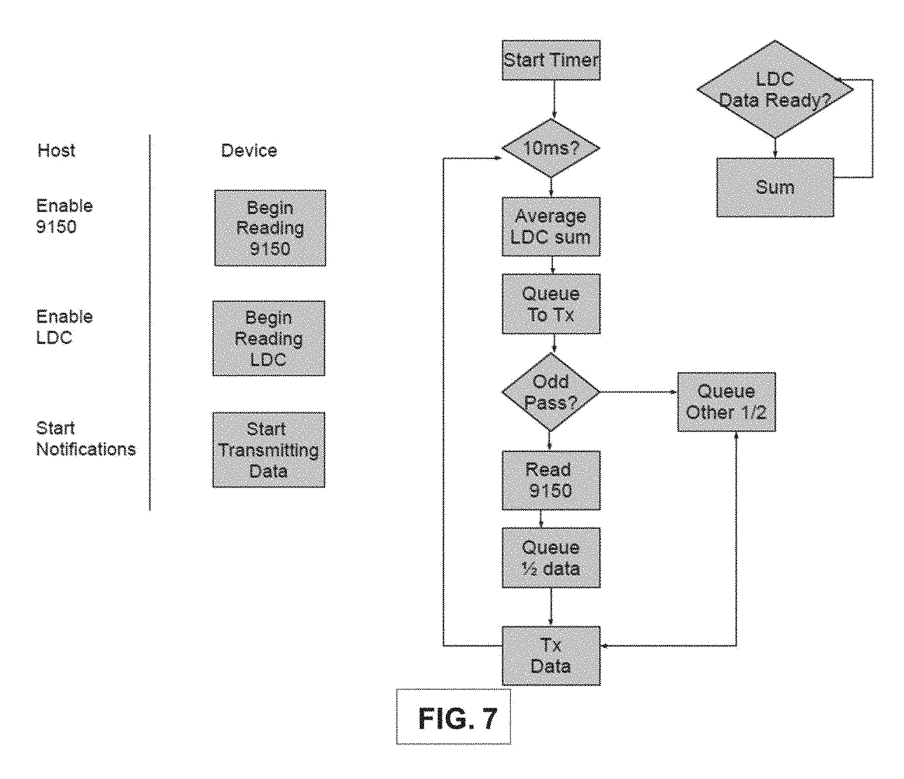

FIG. 7 shows an example firmware design flow chart that may, for instance, help implement an external contactless and wireless heart rate monitor.

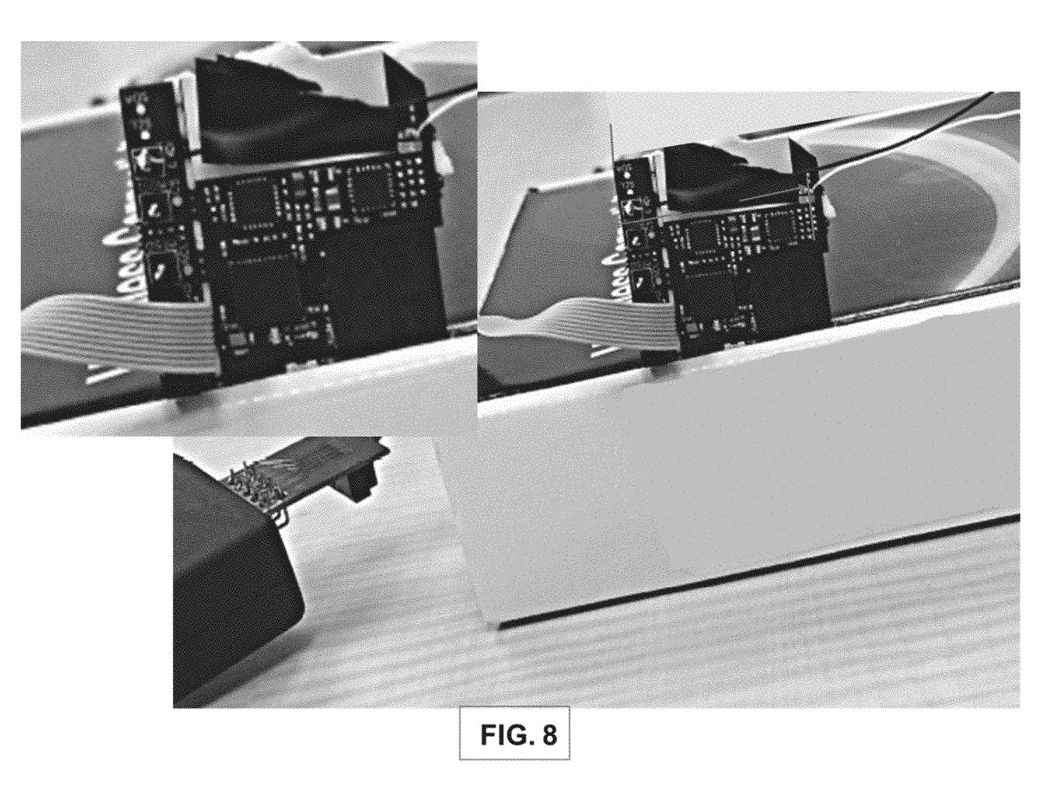

FIG. 8 shows a photograph of the as-built example PSC module being tested for wireless communication range. The printed circuit board is a standard SD card.

The details provided in this Specification, including the figures describe in part particular implementations of the systems for performing the functions explained in this disclosure. Other embodiments could be implemented in any other suitable manner. For example, the attached Appendix describes a particular module physical size and other physical configurations. This disclosure, appendix, and as-built example equipment report on and utilize a standard interface package the SD Card, as opposed to other interfaces such as USB. These configurations are for illustration only. The attached appendix also includes the use of a particular PSC main module systems design. Other embodiments could use different key system blocks, depending upon the implementation.

It may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives, thereof, encompass both direct and indirect communication. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A modular self-powered printed circuit device that is small enough to fit in a wristwatch-like enclosure that:
could include wireless communication, microprocessor, machine learning, sensors and/or digital interface;
could be packaged in a wide variety of external equipment to handle diverse applications; and
could be configured by the original manufacturer and third party developers.
